(19) United States
(12) Patent Application Publication
(10) Pub. No.: US 2016/0350506 A1
(43) Pub. Date: Dec. 1, 2016

(54) SYSTEMS AND METHODS TO MODEL AND MEASURE JOINT DISORDER TREATMENT EFFICACY

(71) Applicant: Medical Companion, LLC, Milwaukee, WI (US)

(72) Inventors: Navjot Kohli, River HIlls, WI (US); Jivtesh Singh, Padstow (AU)

(21) Appl. No.: 14/726,149

(22) Filed: May 29, 2015

(51) Int. Cl. G06F 19/00

(52) U.S. Cl. CPC G06F 19/3437; G06F 19/3443; G06F 19/3487; G06F 19/322

(57) ABSTRACT

Computer implemented methods and systems for determining a probability of one or more outcomes of a therapeutic treatment of a patient having a musculoskeletal joint disorder is provided.

### FIELD OF INVENTION

This present disclosure relates generally to systems and methods to determine the probabilities of outcomes of therapeutic treatments for a patient having a musculoskeletal joint disorder.

### BACKGROUND

The term “Evidence-Based Medicine” or “Evidence-Based Practice” has been defined as the conscientious, explicit, and judicious use of current best evidence in making decisions about the care of individual patients. It integrates clinical expertise, patient values, and the best research evidence in the decision making process for patient care. Clinical expertise refers to the clinician's cumulated experience, education and clinical skills. A patient brings to the encounter with his/her physician his or her own personal preferences and unique concerns, expectations, characteristics, and values. The best research evidence is usually found in clinically relevant research that has been conducted using sound methodology. While the evidence, by itself, is not determinative, it can help support the patient care process.

The value of the research evidence depends on its reliability, objectivity, consistency, and validity. As applied in orthopedic practice to treat joint disorders, for example, where treatment often involves restoring range of motion to joints through implanting prosthetic devices, it is desirable that the efficacy and/or potential success of such treatment be measured and/or appraised based on research evidence.

There is, therefore, a need for a method to determine a probability of one or more outcomes that may result from a therapeutic treatment of a patient having a musculoskeletal joint disorder.

### SUMMARY

In one aspect of the present disclosure, a computer-implemented method for determining a probability of one or more outcomes of a therapeutic treatment of a patient having a musculoskeletal joint disorder is provided, the method comprising: (a) receiving a first dataset comprising datapoints associated with a plurality of subjects who have previously undergone the therapeutic treatment for a musculoskeletal joint disorder; (b) extracting a plurality of datapoints from the first dataset; (c) determining a correlation between the datapoints extracted in step (b); (d) selecting a subset of the extracted datapoints based on the correlation determined in step (c); (e) creating an outcome model based on the subset of the extracted datapoints; (f) receiving a record of the patient; (g) comparing data from the patient record to the outcome model; and (h) determining one or more outcome probabilities of the therapeutic treatment based on the patient record and the outcome model.

In one embodiment, the first dataset comprises one or more of subject datapoints, treatment datapoints, and treatment outcome datapoints.

In one embodiment, determining a correlation between the extracted datapoints comprises the steps of: identifying subject datapoints; identifying treatment datapoints; identifying treatment outcome datapoints; and determining a relationship between the subject datapoints, the treatment datapoints, and the treatment outcome datapoints.

In one aspect, a system for determining a probability of one or more outcomes of a therapeutic treatment of a patient having a musculoskeletal joint disorder is provided.

In one aspect, a computer-readable storage medium having instructions stored therein for performing a process for determining a probability of one or more outcomes of a therapeutic treatment of a patient having a musculoskeletal joint disorder is provided.

### DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, wherein:

FIG. 1 is a flow diagram illustrating the methods of the present disclosure.

FIG. 2 is an illustration of a functional block diagram of a system which may be used to implement aspects of the present disclosure;

FIG. 3 is a logical flow diagram illustrating a method for determining a probability of one or more outcomes of a therapeutic treatment according to aspects of the present disclosure;

FIG. 4 is a logical flow diagram illustrating the process to generate an outcome model according to aspects of the present disclosure;

FIG. 5 is a logical flow diagram illustrating the process to analyze a patient record according to aspects of the present disclosure; and

FIG. 6 is a block diagram illustrating example hardware components of a computing device to implement the methods according to aspects of the present disclosure.

### DETAILED DESCRIPTION

The following description provides specific details for a thorough understanding of, and enabling description for, various embodiments of the present disclosure. One skilled in the art will understand that the present disclosure may be practiced without many of these details. It is intended that the terminology used in this present disclosure be interpreted in its broadest reasonable manner, even though it is being used in conjunction with a detailed description of certain embodiments of the present disclosure. Although certain terms may be emphasized below, any terminology intended to be interpreted in any restricted manner will be overtly and specifically defined as such in this Detailed Description section. The term “based on” or “based upon” is equivalent to the term “based, at least in part, on” and thus includes being based on additional factors, some of which are not described herein. References in the singular are made merely for clarity of reading and include plural references unless plural references are specifically excluded. The term “or” is an inclusive “or” operator and is equivalent to the term “and/or” unless specifically indicated otherwise. For brevity, words importing the masculine gender shall include the feminine and vice versa.

Whether a particular treatment will be successful for a particular patient depends on various factors, only some of which are related to the patient. Determining which factors impact the efficacy of treatment options over a wide patient population would assist the physician in selecting a treatment for a particular patient and lead to higher patient satisfaction as well as a more efficient and cost effective practice. These factors may be used to develop an ideal outcome model for each treatment option, which will provide patients and practitioners a means to estimate the probability of success of a particular treatment option for a specific patient and a means to determine the best treatment protocol for a particular patient.

The methods of the present disclosure may use a sufficiently large amount of data on joint disorder treatments and their subjects, and learn to select predictors of a successful treatment. In one embodiment, the method of the present disclosure creates an outcome model by determining a correlation between predictors and one or more outcomes of a treatment. Examples of predictors that may be used include age of the subject, comorbidity of the subject, treating physician, range of motion measurements, type of procedure, and the hospital where the procedure was performed. The methods of the present disclosure may make the selection of the predictors iteratively upon evaluating the adequacy of the model created. In one embodiment, as additional reference data or evidence becomes available, a model may be refined and/or modified to better reflect the evidence.

In one embodiment, the created model is used to analyze a current patient's condition and/or progress to determine one or more probabilities of certain outcomes. The following are illustrative examples of how the methods of the present disclosure may be used.

A practitioner discusses a total knee replacement surgery with a patient, and to see how well a particular surgical approach would work with this patient, he/she enters the patient data into a system implementing the methods of the present disclosure. The system analyses the patient data in view of the ideal outcome model and may provide an assessment indicating, for example, (1) the probability of revision after the surgery, for example a 10% probability, a 15% probability, and the like; (2) the probability of recovery within 2 months after the surgery, for example, 25%, 50% and the like; (3) the increase or decrease in the probability of revision after a number of years, for example after 2.5 years, after 3 years, and the like; (4) the expected range of motion of the joint in six months after the surgery; (5) the approximate amount of time after the surgery that the patient would be able to return to work; and (6) the percentage increase in the patient's functional score. As used herein, the term “revision” refers to a surgical procedure to “revise” a patient's joint replacement. The procedure can range from a simple adjustment to complex surgery. As used herein, the term “functional score” refers to a score that indicates the physical ability of a person to perform certain tasks, or the amount of impairment or disability. The functional score can also include the amount of pain a patient is experiencing.

In yet another example, a practitioner is being consulted by a patient who had undergone a shoulder replacement surgery, four months of post-surgical physical therapy, and yet is still in pain without improvement to his range of motion. The practitioner enters the patient data into the system implementing the methods of the present disclosure, and after analyzing the patient data in view of the ideal outcome model, the system may provide an assessment indicating one or more of the following, for example: (1) a 90% probability of a revision; (2) a change of post surgical therapy; (3) whether smoking decreases the probability of success; and (4) the probability of the patient returning to full function after a certain period of time.

In one aspect of the present disclosure, a computer-implemented method for determining a probability of one or more outcomes of a therapeutic treatment of a patient having a musculoskeletal joint disorder is provided. In one embodiment, the method comprises: (a) receiving a first dataset comprising datapoints associated with a plurality of subjects who have previously undergone the therapeutic treatment for a musculoskeletal joint disorder; (b) extracting a plurality of datapoints from the first dataset; (c) determining a correlation between the datapoints extracted in step (b); (d) selecting a subset of the extracted datapoints based on the correlation determined in step (c); (e) creating an outcome model based on the subset of the extracted datapoints; (f) receiving a record of the patient; (g) comparing data from the patient record to the outcome model; and (h) determining one or more outcome probabilities of the therapeutic treatment based on the patient record and the outcome model.

In practice, using the methods of the present disclosure, the clinician may prescribe a treatment for a patient based on the determined outcome probabilities. After treatment, the actual outcome may be assessed and information related to the treatment and actual outcome may then be added to the first dataset.

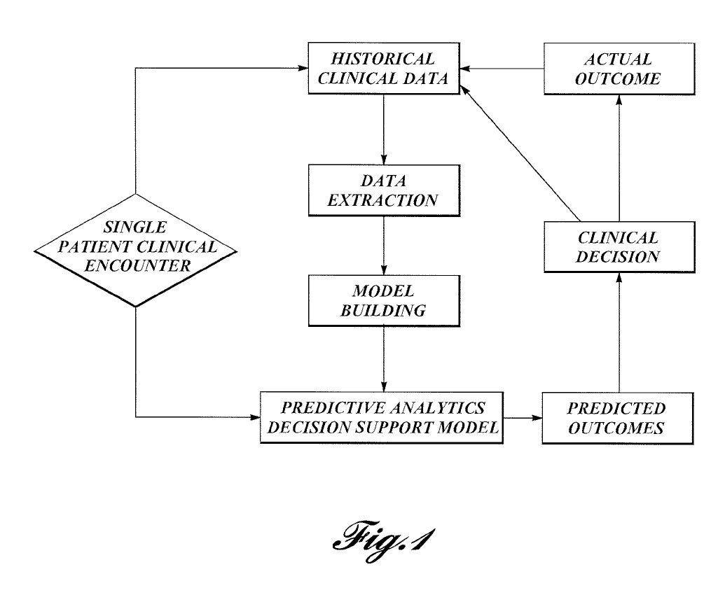

FIG. 1 illustrates an overview of the methods of the present disclosure. As shown in FIG. 1, historical clinical data is gathered from a plurality of subjects who have previously undergone treatment for a joint disorder. The historical clinical data is stored in a database. The historical clinical data can include data on subjects' medical histories, treatments, and treatment outcomes, as more fully described herein. Data is extracted from the historical clinical data and used to build a model to predict a treatment outcome for a particular patient. Based on the prediction, the clinician prescribes a treatment for the patient. The actual outcome of the treatment is assessed and the data related to the patient (e.g., medical history, treatment, and outcome) is added to the historical clinical database.

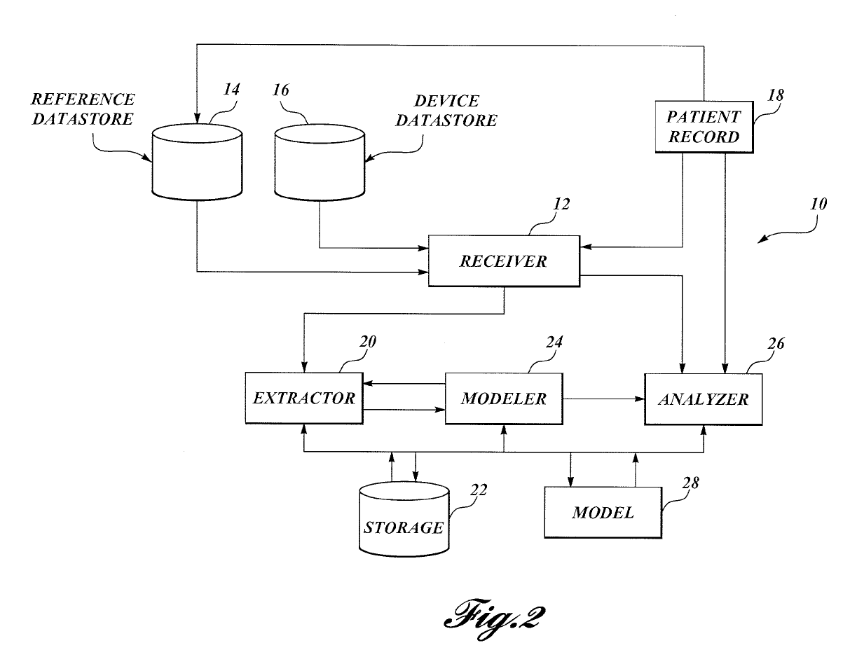

FIG. 2 illustrates a system 10 used to determine a probability of one or more outcomes of a therapeutic treatment of a patient having a musculoskeletal joint disorder according to one embodiment of the present disclosure. System 10 includes functional modules receiver 12, extractor 20, modeler 24, analyzer 26, and model 28. System 20 may also include internal storage 22. System 10 in FIG. 2 may include less or more functional modules, and may be a stand-alone device, or a subsystem in a device or an element of a larger system. The functional modules may be combined or each may be broken down into submodules. System 10 and each functional module may be implemented in hardware, firmware, software, or a combination thereof. System 10 in FIG. 2 may be implemented in a computing device, or in multiple computing devices.

Receiver 12 may be adapted to receive data associated with subjects who have undergone joint replacement treatment in the past. These data may be referred to as “reference data” or “historical clinical data” in this specification. The reference data comprises datapoints. The datapoints may include one or more of subject datapoints, treatment datapoints, and treatment outcome datapoints.

As used herein “subject datapoints” refers to personal information of a subject. Non-limiting examples of subject datapoints include demographic information (e.g. age, gender, residency, and marital status), medical history prior to joint replacement surgery (e.g. previous surgery, previous injuries), and co-morbidities (e.g. diabetes, obesity, cancer). The ages of subjects may be considered as a subset of the subject datapoints.

As used herein, “treatment datapoints” refers to datapoints associated with the treatment the subject has received to address their musculoskeletal joint disorder. Non-limiting examples of treatment datapoints include non-surgical and surgical datapoints, for example rest, medication, physical therapy, surgical procedures, implanted devices, site of care, and the like.

Surgical procedures datapoints may be considered a subset of the treatment datapoints. Non-limiting examples of surgical procedure datapoints may include Total Knee Arthroplasty, Total Shoulder Arthroplasty, Knee Ligament Repair, Anterior Cruciate Ligament Reconstruction (ACL), Arthroscopic Lateral Retinaculum Release, Open Reduction and Internal Fixation of the Hip (ORIF), Knee reconstruction (including ACL/PCL/PLC/MCL/LCL), Cervical fusion, Ankle Fusion, thoracic fusion and the like. Procedure datapoints may also relate to the approach taken (for example, Anterior, Lateral, Posterior, Collateral, Lateral, or Medial), the prosthetic selected, the antibiotic used, the cement used, and the like. Any special technique performed during the procedure may also be included as procedure datapoints. Special techniques may include techniques other than those routinely used during a procedure

Care site datapoints may be considered a subset of the treatment datapoints. Non-limiting examples of care site datapoints include information associated with the sites where the subjects received care, for example the clinic and/or hospital, the physicians who provided treatment, dates of care, and the like.

As used herein, “treatment outcome datapoints” refers to the outcome of a surgical procedure. Non-limiting examples of treatment outcome datapoints include range of motion measurements taken after surgery, results of tests, e.g. Hawkin's Test, strength and gait analysis, time to revision, time to return to work, and functionality scores (e.g. amount of pain and function reported by subjects pre and post treatment, for example the reported Hip and Knee scores, SF-12m, SF-36 Oswestry and the like.)

Each set of datapoints may be further grouped into subsets, for example, subsets of subject ages, gender, diabetes co-morbidity, physician names, revisions, pre-op functionality scores, and the like.

Receiver 12 in FIG. 1 receives reference data from datastore 14. Receiver 12 may be adapted to further receive implanted device data from device datastore 16. Device data may include data related to prosthetic devices, for example, model number, serial number, date and site of manufacture, name of manufacturer, sales number, and the like. Device data may also be included in the reference data received from reference datastore 14. Receiver 12 may further receive data from other datastores.

Receiver 12 in FIG. 2 is also adapted to receive patient record 18. Patient record 18 may include information associated with a particular patient for whom outcome probabilities is being determined. Data from the patient record 18 can also be added to the data in reference datastore 14. Data from the patient record 18 can be added to reference datastore 14 after each encounter between the clinician and the patient. Receiver 12 may further be adapted to determine whether the data it receives is reference data, device data or patient record. Receiver 12, upon determining that the received data is reference data or device data, may be adapted to send the data to extractor 20, and upon determining that the received data is patient record 18, to send the data to analyzer 26.

Extractor 20 may be adapted to select and extricate, from the reference data, a subset of datapoints, referred to herein as “attributes” to be used in creating an outcome model, and to send these attributes to modeler 24. It is contemplated that extractor 20 initially uses a preliminary criteria for selecting these attributes in the reference data. Extractor 20 may be further adapted to receive a feedback from modeler 24 and to use this feedback to modify its criteria for selecting the attributes from the reference data. In one example, extractor 20 initially selects ages, genders, types of procedures, antibiotic information, range of movement measurements, physicians, hospitals, and revisions as the attributes, and after receiving a feedback from modeler 24, extractor 20 adds, as an attribute, information on the cement used.

As shown in FIG. 2, extractor 20 may exchange data with internal storage 22. Extractor 20 may receive part or all of the reference data from internal storage 22. It is contemplated that extractor 20 also receives other data it may need to select the attributes. Internal storage 22 may be a hard drive, a solid-state storage, a magnetic storage, or a subsystem with storage memory.

Modeler 24 may be adapted to create an outcome model or ideal that defines a relationship between subject datapoints and/or treatment datapoints, and treatment outcome datapoints. Modeler 24 is adapted to measure correlations and/or dependence between the attributes received from extractor 20. For example, modeler 24 may measure correlation between subject ages and post-op functionality scores, between surgical procedure and post-op functionality scores, and/or between device and post-op functionality scores. Modeler 24 may be adapted to automate T-tests (i.e. two sample means test) to determine if subsets are statistically different within a certain percentage of confidence level. It is contemplated that modeler 24 evaluates groups of the datapoints and/or the extracted attributes using one or more statistical analysis methods.

The creation of the outcome model may be referred to as predictive modeling, the goal of which is to find a relationship between various subject datapoints and/or treatment datapoints, and the treatment outcome datapoints. As previously discussed, the outcome model may be used to determine one or more outcome probabilities based on the subject datapoints and/or the treatment datapoints.

The modeler 24 can use various techniques to create the outcome model. Non-limiting examples of techniques used by modeler 24 include regression techniques, machine learning, and modeling algorithms such as time series models, decision trees, artificial neural networks (ANNs), support vector machines (SVMs), naive Bayes (NB), and k-nearest neighbors (KNN).

Modeler 24 may also be adapted to provide feedback to extractor 20, informing extractor 20 of the suitability of the selected attributes for creating the outcome model. Modeler 24 may determine that it needs an additional attribute, or a different attribute to create the outcome model. Modeler 24 may inform extractor 20 to provide more attributes from a particular set of datapoints, and/or less attributes from another set of datapoints. It is contemplated that exchanges between extractor 20 and modeler 24 occur more often during the initial creation of the outcome model. This may be considered as the learning period. Modeler 24 may refine and/or modify the outcome model when additional reference data is provided to the system.

Model 28 as shown in FIG. 2 is the outcome model created by modeler 24. As previously discussed, modeler 24 may be adapted to generate an output given one or more inputs, the output being generated following certain rules in manipulating the one or more inputs.

Analyzer 26 may be adapted to receive from receiver 12 data associated with patient record 18. The patient record may include patient datapoints and proposed treatment datapoints. As used herein “patient datapoints” refers to personal information of a specific patient. Non-limiting examples of patient datapoints include demographic information (e.g. age, gender, residency, and marital status), medical history (e.g. previous surgery, previous injuries), and co-morbidities (e.g. diabetes, obesity, cancer). As used herein, “proposed treatment datapoints” may include information related to the proposed treatment. Non-limiting examples of proposed treatment datapoints include non-surgical and surgical datapoints, for example rest, medication, physical therapy, surgical procedures, implanted devices, site of care, and the like.

It is also contemplated that analyzer 26 is adapted to receive patient record 18 directly and to extract relevant patient datapoints and/or proposed treatment datapoints from the patient record 18. Analyzer 26 may be further adapted to receive subject datapoints and treatment datapoints from modeler 24, and extract the corresponding patient datapoints and proposed treatment datapoints from the patient record 18.

As shown in FIG. 2, analyzer 26 is also adapted to receive model 28. In one embodiment, analyzer 26 is adapted to analyze the patient datapoints and/or proposed treatment datapoints in view of model 28. In analyzing the patient datapoints and proposed treatment datapoints, analyzer 26 may match the patient datapoints and proposed treatment datapoints to certain pattern(s) in model 28. In one embodiment, model 28 defines one or more relationships between the subject datapoints, treatment datapoints and treatment outcome datapoints, and analyzer 26 determines one or more outcome probabilities of a proposed treatment for the patient based on the patient datapoints, the proposed treatment datapoints, and the outcome model.

Analyzer 26 may be adapted to determine how closely the patient datapoints match the subject datapoints in model 28. It is contemplated that the more closely matched the patient datapoints are with the subject datapoints in model 28, the higher the probability of a treatment outcome for that patient. In one embodiment, for example, analyzer 26 determines a probability of a revision. In another embodiment, analyzer 26 also determines a probability of the patient returning to work after a specified amount of time, and/or a probability of the patient returning to full function after a specified period of time.

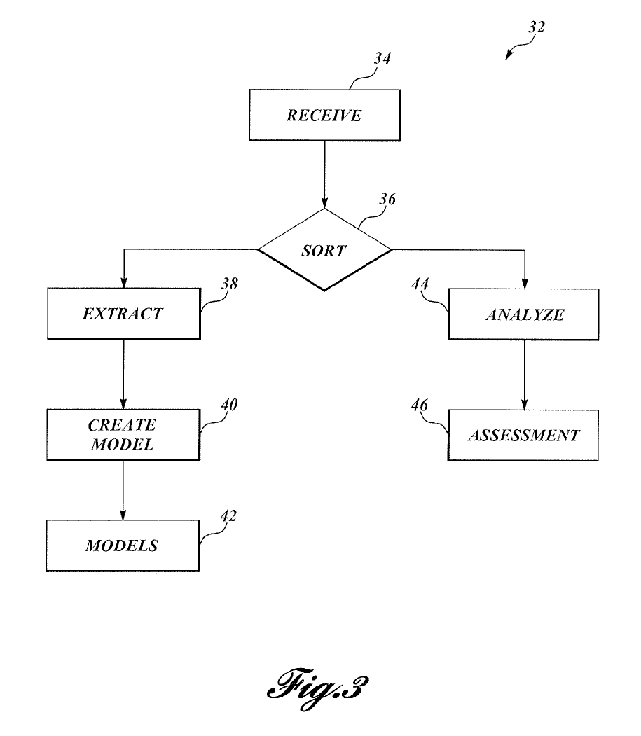

FIG. 3 is a logical flow diagram illustrating a process 32 to determine a probability of one or more outcomes of a therapeutic treatment of a patient having a musculoskeletal joint disorder according to one embodiment of the present disclosure. The process, as well as other processes described herein, are described for clarity in terms of operations performed in particular sequences by particular devices or elements of a system. It is noted, however, that this process and other processes described herein, are not limited to the specified sequences, devices, or elements. Certain processes may be performed in different sequences, in parallel, be omitted, or supplemented by additional processes, whether or not such different sequences, parallelism, or additional processes are described herein. The processes disclosed may also be performed on or by other devices, elements, or systems, whether or not such devices, elements, or system are described herein. These processes may also be embodied in a variety of ways, for example, on an article of manufacture, e.g. as a computer-readable instructions stored in a computer-readable storage medium, or be performed as a computer-implemented process. These processes may also be encoded as computer-executable instructions and transmitted via a communication medium.

Process 32 begins at 34 where information is received. The information may be reference data and/or a patient record. The information may be received from external or internal datastores or databases, or from a user (e.g. a practitioner wishing to evaluate a patient's treatment). As previously discussed, while reference data are historical data on subjects who have undergone certain treatments in the past and experienced known outcomes, a patient record is information related to a patient currently under evaluation.

Process 32 then flows to 36 where a determination is made as to where to send the received information. If the information is reference data, process 32 continues to 38 where attributes related to subject datapoints, treatment datapoints, and treatment outcome datapoints are extracted.

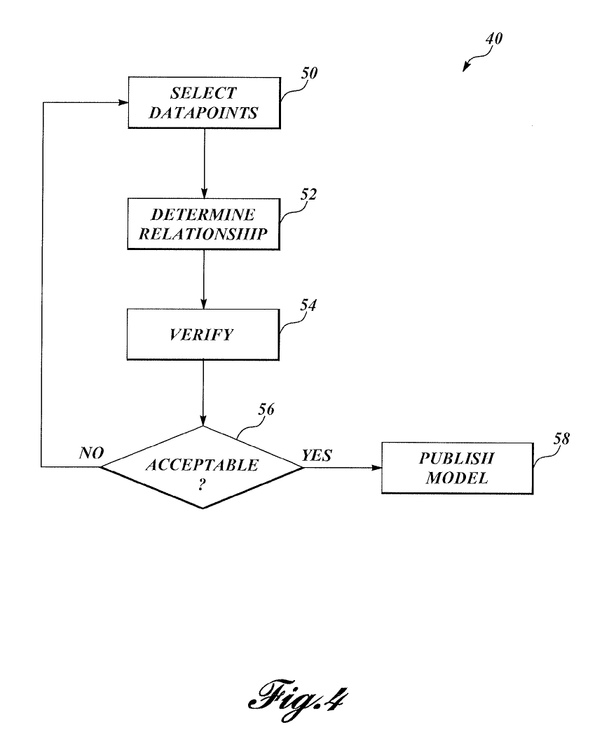

Process 38 continues to 40 where models are created based at least on the attributes extracted in process 38. FIG. 4 is a logical flow diagram illustrating process 40 in one embodiment of the present disclosure.

As shown in FIG. 4, process 40 begins at 50 where a subset of datapoints are selected and/or extracted from the reference data. The subset of datapoints, or attributes, may be selected from one or more sets of datapoints. Process 50 flows to 52 where one or more relationships between the subject datapoints and/or treatment datapoints and treatment outcome datapoints are determined. The relationship may be determined iteratively. Regression techniques or machine (self) learning techniques may be used to determine the relationship. The relationships are analyzed to create an outcome model.

Process 40 continues to 54 where the model is tested against selected reference data. In one embodiment, the reference data may be used to verify the level of accuracy of the model, for example how well the model predicts treatment outcomes from a set of subject datapoints and treatment datapoints.

After the level of accuracy is determined, process 54 flows to 56 where it is determined if the level of accuracy is acceptable or if there is a need for refinement of the model. If the accuracy of the model is deemed unacceptable, then a refinement or modification of the model may be needed. In one embodiment, different attributes may be needed and process 40 loops back to 50. If the accuracy of the model is deemed acceptable, then process 40 continues to 58 where the model is published or saved.

Determining whether the accuracy of a model is acceptable may be based on error measurements. In one embodiment, the accuracy is determined by calculating the residuals of the treatment outcome datapoints. A threshold value of the residual may be identified as the indicator of an acceptable accuracy of the model.

Returning to FIG. 3, process 40 flows to 42 where the model created in 40 is stored for subsequent use.

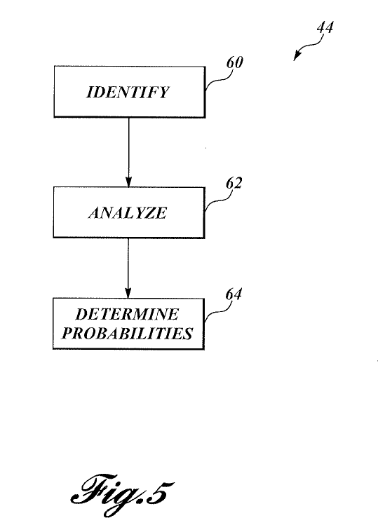

At process 36 in FIG. 3, if the received information is determined to be a patient record, process 36 flows to 44 where the patient record is analyzed. FIG. 5 is a logical flow diagram of process 44 in one embodiment of the present disclosure.

Process 44 may start at 60 where patient datapoints and proposed treatment datapoints corresponding to subject datapoints and treatment datapoints selected at 40 are identified in, and extracted from, the patient record. The subject datapoints and treatment datapoints selected at 40 may include the subject's age, gender, co-morbidity, type of prosthetic device implanted, data of implant, the physician performing the implant, and the like.

Process 44 continues to 62 where the patient datapoints and proposed treatment datapoints selected from the patient record are analyzed in view of the model created at process 40. In one embodiment, the patient datapoints and the proposed treatment datapoints from the patient record are compared to the subject datapoints and the treatment datapoints in the model.

Process 62 flows to 64 where the probabilities of one or more outcomes is determined based on the analysis at 62. In one embodiment, a probability is determined by evaluating how much the patient datapoints deviate or depart from the model. For example, a patient datapoint indicating a smoking habit may lead to an increased probability of a revision. In another example, a patient datapoint indicating that the patient is a sports player may be evaluated against a modified outcome model that includes sport playing as a subject datapoint.

Returning to FIG. 3, process 44 flows to 46 where an assessment of the patient's proposed treatment is provided to the user. In one embodiment, the assessment may indicate the expected outcome of the patient's treatment given no change in the treatment plan. In another embodiment, the assessment may provide options for the next step in the patient's treatment plan given a particular outcome objective. In one aspect of the embodiment, the assessment may suggest changes to the current treatment plan to achieve an outcome objective.

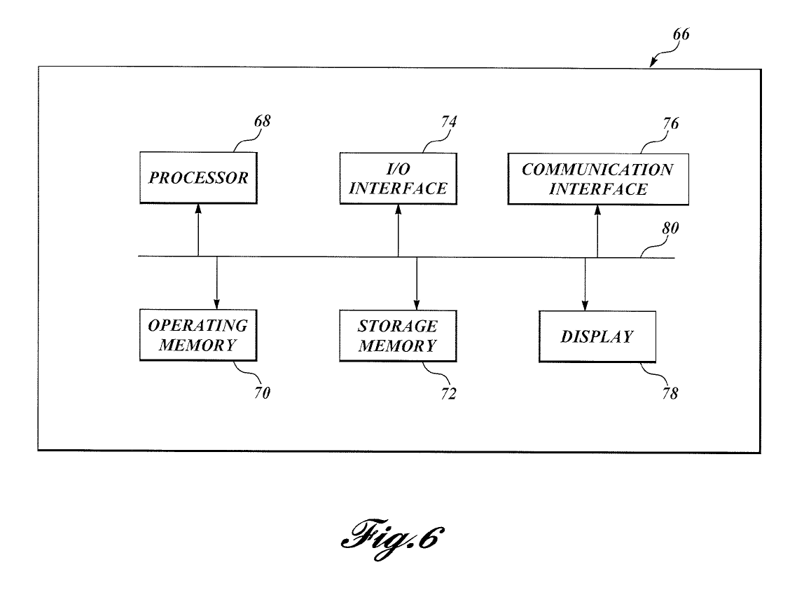

FIG. 6 is a high-level illustration of example hardware components of a computing device 66, which may be used to practice various aspects of the present disclosure. Computing device 66 in FIG. 6 may be employed to perform process 32 of FIG. 3. As shown, computing device 66 includes processor block 68, operating memory block 70, data storage memory block 72, input/output interface block 74, and communication interface block 76, and display component block 78. These aforementioned components may be interconnected by bus 80.

Computing device 66 may be virtually any type of general- or specific-purpose computing device. For example, computing device 66 may be a user device such as a desktop computer, a laptop computer, a tablet computer, a display device, a camera, a printer, or a smartphone. Likewise, computing device 66 may also be server device such as an application server computer, a virtual computing host computer, or a file server computer.

Computing device 66 includes at least one processor block 68 adapted to execute instructions, such as instructions for implementing the above-described processes. The aforementioned instructions, along with other data (e.g., datasets, metadata, operating system instructions, etc.), may be stored in operating memory block 70 and/or data storage memory block 72. In one example, operating memory block 70 is employed for run-time data storage while data storage memory block 72 is employed for long-term data storage. However, each of operating memory block 70 and data storage memory block 72 may be employed for either run-time or long-term data storage. In one embodiment, one or more outcome models may be stored in operating memory block 70 and/or data storage block 72.

Each of operating memory block 70 and data storage memory block 72 may also include any of a variety of data storage devices/components, such as volatile memories, semi-volatile memories, non-volatile memories, random access memories, static memories, disks, disk drives, caches, buffers, or any other media that can be used to store information. However, operating memory block 70 and data storage memory block 72 specifically do not include or encompass communications media, any communications medium, or any signals per se.

Also, computing device 66 may include or be coupled to any type of computer-readable media such as computer-readable storage media (e.g., operating memory block 70 and data storage memory block 72) and communication media (e.g., communication signals and radio waves). While the term computer-readable storage media includes operating memory block 70 and data storage memory block 72, this term specifically excludes and does not encompass communications media, any communications medium, or any signals per se.

Computing device 66 also includes input/output interface block 74, which may be adapted to enable computing device 66 to receive input from users or other devices, or to send output to user or other devices. In one embodiment, some or all of the reference data and/or patient record are received through the input/output interface block 74, and sent to processing block 68 and/or operating memory block 70 via us 80. In addition, input/output interface block 74 may be adapted to transmit data to display component block 78 to render displays. In one example, display component block 78 includes a frame buffer, graphics processor, graphics accelerator, or a virtual computing host computer and is adapted to render the displays for presentation on a separate visual display device (e.g., a monitor, projector, virtual computing client computer, etc.). In another example, display component block 78 includes a visual display device and is adapted to render and present the displays for viewing. In one embodiment, an assessment of the efficacy of a patient's musculoskeletal joint disorder treatment is presented to a user via a display device.

Computing device 66 may include communication interface block 76 which may be adapted to transmit data to a communication network via a wired or wireless communication link. In one embodiment, some or all of the reference data and/or patient record may be received by computing device 66 via communication interface block 76.

In one aspect of the present disclosure, a system to determine a probability of one or more outcomes of a therapeutic treatment of a patient having a musculoskeletal joint disorder is provided. In one embodiment, the system comprises: (1) a processing unit configured to: (a) receive a first dataset comprising datapoints associated with a plurality of subjects who have previously undergone the therapeutic treatment for a musculoskeletal joint disorder; (b) extract a plurality of datapoints from the first dataset; (c) determine a correlation between the datapoints extracted in step (b) and the treatment outcome; (d) select a subset of the extracted datapoints based on the correlation determined in step (c); (e) create an outcome model based on the subset of the extracted datapoints; (f) receive a record of the patient; (g) compare data from the patient record to the outcome model; and (h) determine one or more outcome probabilities of the treatment based on the patient record and the outcome model; and (2) a user interface unit configured to present the determined one or more outcome probabilities.

In one aspect, the present disclosure provides a computer-readable storage medium having instructions stored therein for performing a process for determining a probability of one or more outcomes of a therapeutic treatment of a patient having a musculoskeletal joint disorder, the process comprising: (a) receiving a first dataset comprising datapoints associated with a plurality of subjects who have previously undergone the therapeutic treatment for a musculoskeletal joint disorder; (b) extracting a plurality of datapoints from the first dataset; (c) determining a correlation between the datapoints extracted in step (b) and the treatment outcome; (d) selecting a subset of the extracted datapoints based on the correlation determined in step (c); (e) creating an outcome model based on the subset of the extracted datapoints; (f) receiving a record of the patient; (g) comparing data from the patient record to the outcome model; and (h) determining one or more outcome probabilities of the treatment based on the patient record and the outcome model.

While illustrative embodiments have been illustrated and described, it will be appreciated that various changes can be made therein without departing from the spirit and scope of the present disclosure; the technology can be practiced in many ways. Particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. A computer-implemented method for determining a probability of one or more outcomes of a therapeutic treatment of a patient having a musculoskeletal joint disorder, the method comprising:
(a) receiving a first dataset comprising datapoints associated with a plurality of subjects who have previously undergone the therapeutic treatment for a musculoskeletal joint disorder;
(b) extracting a plurality of datapoints from the first dataset;
(c) determining a correlation between the datapoints extracted in step (b);
(d) selecting a subset of the extracted datapoints based on the correlation determined in step (c);
(e) creating an outcome model based on the subset of the extracted datapoints;
(f) receiving a record of the patient;
(g) comparing data from the patient record to the outcome model; and
(h) determining one or more outcome probabilities of the therapeutic treatment based on the patient record and the outcome model.

2. The method of claim 1, wherein the first dataset comprises one or more of subject datapoints, treatment datapoints, and treatment outcomes datapoints.

3. The method of claim 1, wherein the outcome probability is a probability of at least one of a revision, a short-term recovery, and a long-term recovery.

4. The method of claim 1, wherein determining a correlation between the extracted datapoints comprises the steps of:
(a) identifying subject datapoints;
(b) identifying treatment datapoints;
(c) identifying treatment outcome datapoints; and
(d) determining a relationship between the subject datapoints, the treatment datapoints, and the treatment outcome datapoints.

5. The method of claim 4, wherein the relationship is determined using regression analysis.

6. The method of claim 1, further comprising refining the outcome model.

7. The method of claim 1, wherein determining one or more outcome probabilities comprises the steps of:
(a) identifying subject datapoints in the outcome model;
(b) identifying treatment datapoints in the outcome model;
(c) identifying treatment outcome datapoints in the outcome model;
(d) identifying patient datapoints in the patient record that correspond to the subject datapoints identified in step (a);
(e) identifying proposed treatment datapoints in the patient record that correspond to the treatment datapoints identified in step (b); and
(f) determining one or more outcome probabilities based on the outcome datapoints identified in step (c).

8. A system to determine a probability of one or more outcomes of a therapeutic treatment of a patient having a musculoskeletal joint disorder, the system comprising:
a processing unit configured to
(a) receive a first dataset comprising datapoints associated with a plurality of subjects who have previously undergone the therapeutic treatment for a musculoskeletal joint disorder;
(b) extract a plurality of datapoints from the first dataset;
(c) determine a correlation between the datapoints extracted in step (b);
(d) select a subset of the extracted datapoints based on the correlation determined in step (c);
(e) create an outcome model based on the subset of the extracted datapoints;
(f) receive a record of the patient;
(g) compare data from the patient record to the outcome model; and
(h) determine one or more outcome probabilities of the therapeutic treatment based on the patient record and the outcome model; and
a user interface unit configured to present the determined one or more outcome probabilities.

9. A computer-readable storage medium having instructions stored therein for performing a process for determining a probability of one or more outcomes of a therapeutic treatment of a patient having a musculoskeletal joint disorder, the process comprising:
(a) receiving a first dataset comprising datapoints associated with a plurality of subjects who have previously undergone the therapeutic treatment for a musculoskeletal joint disorder;
(b) extracting a plurality of datapoints from the first dataset;
(c) determining a correlation between the datapoints extracted in step (b);
(d) selecting a subset of the extracted datapoints based on the correlation determined in step (c);
(e) creating an outcome model based on the subset of the extracted datapoints;
(f) receiving a record of the patient;
(g) comparing data from the patient record to the outcome model; and
(h) determining one or more outcome probabilities of the therapeutic treatment based on the patient record and the outcome model.
